(19) United States
(12) Patent Application Publication
(10) Pub. No.: US 2015/0107972 A1
(43) Pub. Date: Apr. 23, 2015

(54) TRIP DEVICE FOR CIRCUIT BREAKER

(71) Applicant: LSIS CO., LTD., Anyang-si (KR)

(72) Inventor: Ki Hwan OH, Cheongju-si, Chungcheongbuk-do (KR)

(73) Assignee: LSIS CO., LTD., Anyang-si (KR)

(21) Appl. No.: 14/339,275

(22) Filed: Jul. 23, 2014

(30) Foreign Application Priority Data
Oct. 17, 2013 (KR) 10-2013-0124175

(51) Int. Cl. H01H 1/0233; H01H 1/025

(52) U.S. Cl. CPC H01H 1/0233; H01H 1/025; H01H 2239/072
USPC 200/269

(57) ABSTRACT

A trip device for a circuit breaker disclosed herein includes a first terminal connected to a power source side, a second terminal connected to a load side, and a bimetal having one side connected with the first terminal and the other side connected with the second terminal, such that a current can flow therethrough, wherein the bimetal comes in surface-contact with at least one of the first terminal and the second terminal, with interposing an arc-resistive member therebetween.

### CROSS-REFERENCE TO RELATED APPLICATION

Pursuant to 35 U.S.C. §119(a), this application claims the benefit of earlier filing date and right of priority to Korean Application No. 10-2013-0124175, filed on Oct. 17, 2013, the contents of which are all hereby incorporated by reference herein in its entirety.

### BACKGROUND OF THE DISCLOSURE

1. Field of the Disclosure

This specification relates to a trip device for a circuit breaker, and particularly, to a trip device using a bimetal as a trip mechanism.

2. Background of the Disclosure

In general, a circuit breaker is a type of electric device, which protects a load device and a circuit by manually opening and closing an electric circuit using a handle or automatically blocking a circuit by sensing a fault current, such as a shortcircuit current or the like, upon an occurrence of the fault current.

Hereinafter, a trip device for a circuit breaker according to the related art will be described with reference to FIGS. 1 and 2.

The related art circuit breaker, as illustrated in FIG. 1, may include a case 10, a fixed contact 20 fixed to the case 10, a movable contact 30 contactable with and separated from the fixed contact 20, a switching mechanism 40 that opens and closes the movable contact 30, and a trip device 60 that senses a generation of a fault current, such as a shortcircuit current or the like, so as to automatically trigger the switching mechanism 40 to a trip position. The switching mechanism 40 may include a handle 50 that allows for manual opening and closing, and a crossbar 42 that performs a so-called trigger function of finally unlocking a latch (not illustrated) of the switching mechanism 40 when a bimetal 66 to be explained later is curved.

The trip device 60, as illustrated in FIG. 2, may include a first terminal 62 connected to a power source side, a second terminal 64 connected to a load side, and a bimetal 66 having one side connected with the first terminal 62 and the other side connected with the second terminal 64 such that a current can flow therealong.

In this case, the first terminal 62 and the one side of the bimetal 66 may be connected to each other in a manner that a contact surface 62a of the first terminal 62 and a first contact surface 66a of the bimetal 66 come in surface-contact with each other and are coupled to each other by a first rivet 67a inserted through both of them.

The second terminal 64 and the other side of the bimetal 66 may be connected to each other in a manner that a contact surface 64b of the second terminal 64 and a second contact surface 66b of the bimetal 66 come in surface-contact with each other, and are coupled to each other by a second rivet 67b inserted through both of them.

With the configuration, when a fault current flows, the bimetal 66 may generate heat due to the flowed current.

The bimetal 66 with temperature increased may be curved to right in FIG. 2 and accordingly a pressing member 66c may press the crossbar 42. The crossbar 42 may then be rotated, thereby unlocking the latch of the switching mechanism 40.

When the latch is unlocked, the movable contact 30 may be fast separated from the fixed contact 20 by an elastic force of a trip spring (not illustrated) of the switching mechanism 40.

However, the trip device for the circuit breaker according to the related art, arc may be generated in a micropore (fine pore) between the contact surface 62a of the first terminal 62 and the first contact surface 66a of the bimetal 66 which are in the surface-contact state, and between the contact surface 64b of the second terminal 64 and the second contact surface 66b of the bimetal 66 which are in the surface-contact state.

The generated arc may cause thermal bonding and changes of a resistance value, a quantity of heat generated, and a curved level of the bimetal 66. This may result in lowering of reliability of a trip operation due to a delayed trip.

### SUMMARY OF THE DISCLOSURE

Therefore, an aspect of the detailed description is to provide a trip device for a circuit breaker, capable of preventing thermal bonding and thusly-caused changes of a resistance value, a quantity of heat generated, and a curved level of a bimetal and consequently preventing reliability of a trip operation from being lowered due to a delayed trip, in a manner of preventing a generation of arc from connected (contacted) portions between the bimetal and first and second terminals.

To achieve these and other advantages and in accordance with the purpose of this specification, as embodied and broadly described herein, there is provided a trip device for a circuit breaker, including a first terminal connected to a power source side, a second terminal connected to a load side, and a bimetal having one side connected with the first terminal and the other side connected with the second terminal, such that a current can flow therethrough, wherein the bimetal comes in surface-contact with at least one of the first terminal and the second terminal, with interposing an arc-resistive member therebetween.

In accordance with one exemplary embodiment disclosed herein, the arc-resistive member may be formed of a metal having arc-resistivity and conductivity.

The metal may be silver carbide (AgC).

In this case, the arc-resistive member may be plated on a surface of the bimetal.

In accordance with another exemplary embodiment disclosed herein, the arc-resistive member may be formed of insulating paper.

In this case, a current may flow along a conductive rivet inserted through the arc-resistive member.

The insulating paper may be NOMEX.

The conductive rivet may be formed of copper.

Here, the arc-resistive member may be provided, separate from the bimetal, the first terminal and the second terminal.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a sectional view of a circuit breaker according to the related art;

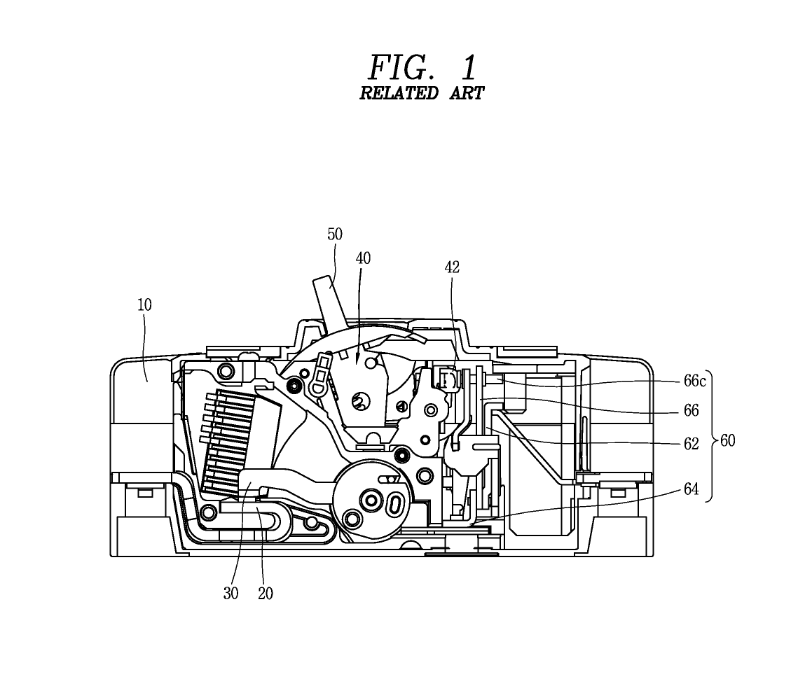

FIG. 2 is a perspective view of a trip device illustrated in FIG. 1;

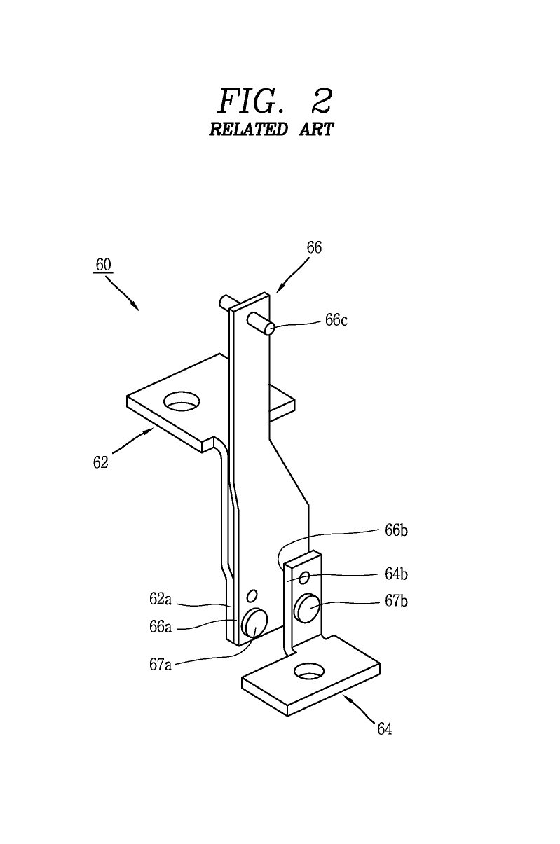

FIG. 3 is a perspective view of a trip device in accordance with a first exemplary embodiment disclosed herein;

FIG. 4 is a perspective view of FIG. 3 viewed from an opposite side;

FIG. 5 is a disassembled perspective view of FIG. 3; and

FIG. 6 is a disassembled perspective view of a trip device in accordance with a second exemplary embodiment disclosed herein.

### DETAILED DESCRIPTION OF THE DISCLOSURE

Description will now be given in detail of a trip device for a circuit breaker the exemplary embodiments, with reference to the accompanying drawings.

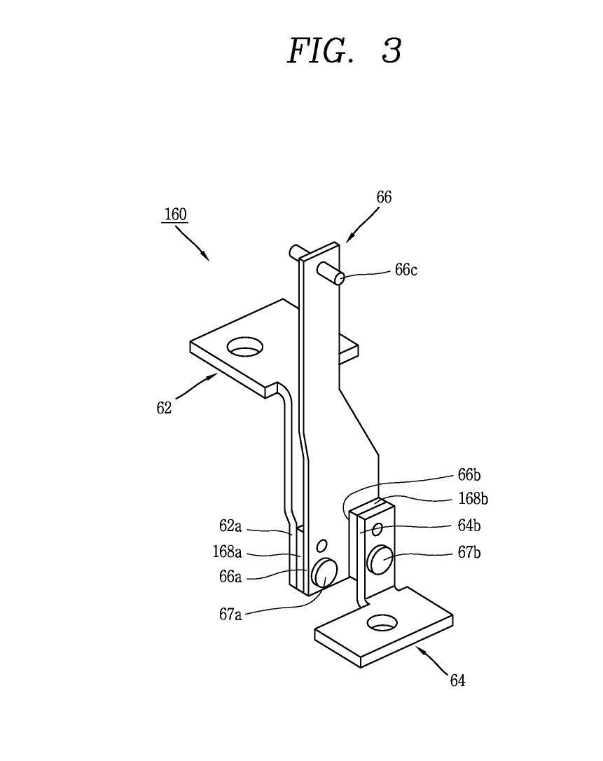

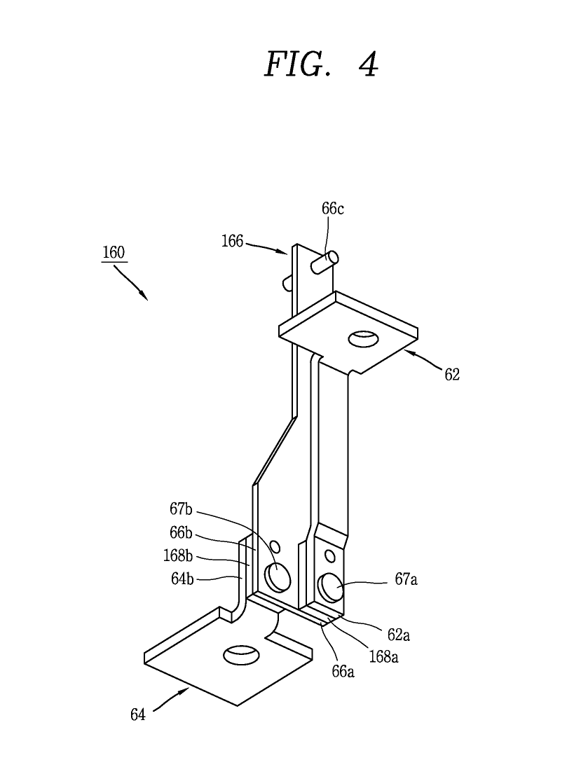

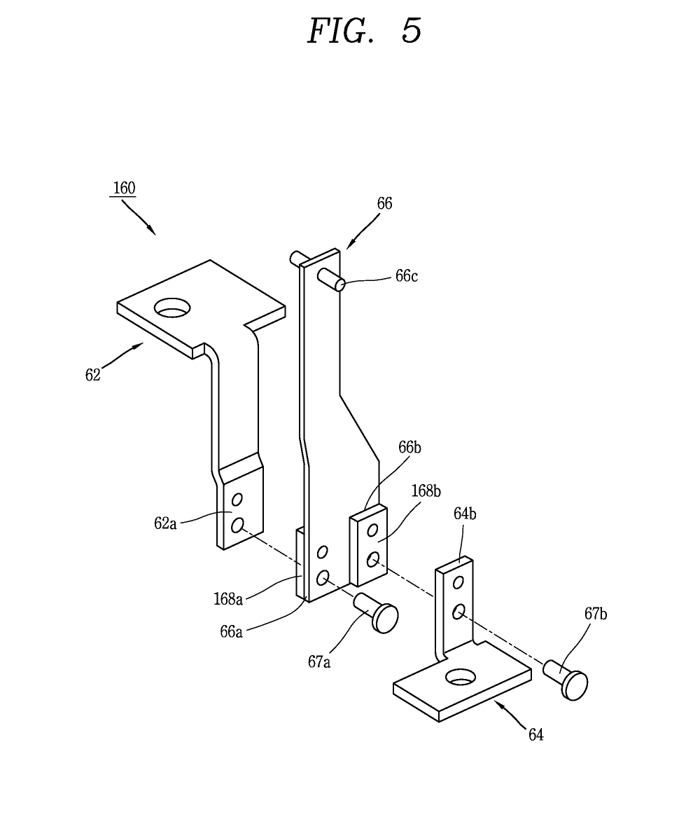

FIG. 3 is a perspective view of a trip device in accordance with a first exemplary embodiment disclosed herein, FIG. 4 is a perspective view of FIG. 3 viewed from an opposite side, and FIG. 5 is a disassembled perspective view of FIG. 3.

As illustrated in FIGS. 3 to 5, a trip device 160 for a circuit breaker according to a first exemplary embodiment disclosed herein may include a first terminal 62 connected to a power source side, a second terminal 64 connected to a load side, and a bimetal 66 having one side connected with the first terminal 62 and the other side connected with the second terminal 64 such that a current can flow.

The first terminal 62 and the second terminal 64 may serve as brackets for supporting the bimetal 66 and simultaneously serve to electrically connect the bimetal 66 to a circuit.

The first terminal 62 may include a contact surface 62a which comes in surface-contact with one surface of a first arc-resistive member 168a to be explained later.

The second terminal 64 may include a contact surface 64b which comes in surface-contact with one surface of a second arc-resistive member 168b to be explained later.

The bimetal 66 may include a pressing member 66c provided on one end portion thereof.

The bimetal 66 may include a first contact surface 66a provided on one surface of the other end portion thereof, and plated with the first arc-resistive member 168a, and a second contact surface 66b provided on a rear surface of the other end portion thereof, and plated with the second arc-resistive member 168b.

Accordingly, the first contact surface 66a of the bimetal 66 may come in surface-contact with the rear surface of the first arc-resistive member 168a, and the second contact surface 66b of the bimetal 66 may come in surface-contact with the rear surface of the second arc-resistive member 168b.

In other words, the first contact surface 66a of the bimetal 66 may come in surface-contact with the contact surface 62a of the first terminal 62 with interposing the first arc-resistive member 168a therebetween.

Also, the second contact surface 66b of the bimetal 66 may come in surface-contact with the contact surface 64b of the second terminal 64 with interposing the second arc-resistive member 168b therebetween.

In this case, the first arc-resistive member 168a and the second arc-resistive member 168b should be formed of a material having arc-resistivity and conductivity, such that a current can stably flow from the contact surface 62a of the first terminal 62 to the contact surface 64b of the second terminal 64 via the first contact surface 66a of the bimetal 66 and the second contact surface 66b of the bimetal 66.

That is, the first arc-resistive member 168a and the second arc-resistive member 168b should be formed of a material having arc-resistivity and conductivity, such that an arc generation can be prevented and a current can flow between the contact surface 62a of the first terminal 62 and the first contact surface 66a of the bimetal 66, and an arc generation can be prevented and a current can flow between the contact surface 64b of the second terminal 64 and the second contact surface 66b of the bimetal 66.

The first arc-resistive member 168a and the second arc-resistive member 168b should be formed of a metal, so as to be plated on the bimetal 66 for facilitation of fabrication.

Therefore, the first arc-resistive member 168a and the second arc-resistive member 168b may be formed of silver carbide, which is a metal having arc-resistivity and conductivity, so as to be plated on the first contact surface 66a and the second contact surface 66b of the bimetal 66.

However, the present disclosure may not be limited to this.

For instance, the first arc-resistive member 168a and the second arc-resistive member 168b may be plated on the contact surface 62a of the first terminal 62 and the contact surface 64b of the second terminal 64, other than the first contact surface 66a and the second contact surface 66b of the bimetal 66.

As another example, the first arc-resistive member 168a and the second arc-resistive member 168b, as will be explained later, may be formed as a plate-like member, separate from the bimetal 66, the first terminal 62 and the second terminal 64, and then disposed between the first contact surface 66a of the bimetal 66 and the contact surface 62a of the first terminal 62 and between the second contact surface 66b of the bimetal 66 and the contact surface 64b of the second terminal 64.

Also, the first arc-resistive member 168a and the second arc-resistive member 168b may be formed of a different material having arc-resistivity and conductivity in a plating manner or separately formed of such material.

In addition, in the bimetal 66, which is a bonded member having one surface and a rear surface made of different materials from each other, if the first terminal 62 and the second terminal 64 are connected to only one of the one surface and the rear surface, a material of the connected surface may be heated so as to be cut due to being melted or reversely curved. To prevent this, the bimetal 66 may be connected to the first terminal 62 at the first contact surface 66a which is one surface of the other end portion thereof, and connected to the second terminal 64 at the second contact surface 66b which is the rear surface of the other end portion thereof.

Then, in order for the bimetal 66 to be fixedly coupled to the first terminal 62, the contact surface 62a of the first terminal 62, the first arc-resistive member 168a and the first contact surface 66a of the bimetal 66 may be coupled by a first rivet 67a which is inserted through all of them.

Also, in order for the bimetal 66 to be fixedly coupled to the second terminal 64, the contact surface 64a of the second terminal 64, the second arc-resistive member 168b and the second contact surface 66b of the bimetal 66 may be coupled by a second rivet 67b which is inserted through all of them.

The first rivet 67a and the second rivet 67b may be replaced with other fastening members, such as bolts and the like.

The same or equivalent parts as those of the related art are given with the same or equivalent reference numbers.

Hereinafter, operational effects of the trip device 160 for the circuit breaker according to the first exemplary embodiment disclosed herein will be described.

That is, in the trip device 160 for the circuit breaker according to the first exemplary embodiment disclosed herein, a current applied from a power source side may flow toward a load side sequentially along the contact surface 62a of the first terminal 62, the first arc-resistive member 168a, the first contact surface 66a of the bimetal 66, the second contact surface 66b of the bimetal 66, the second arc-resistive member 168b and the contact surface 64b of the second terminal 64.

Accordingly, the bimetal 66 may generate heat by the current flowing from the first contact surface 66a to the second contact surface 66b.

When a temperature of the bimetal 66 is raised due to the generated heat, the bimetal 66 may be bent to the right side in the drawing, referring to FIG. 3.

Here, the bimetal 66 may exhibit a less amount of heat generated and a low curved level when a normal current flows. Accordingly, the bimetal 66 may not trip the switching mechanism 40 of the circuit breaker.

However, when a fault current, such as a shortcircuit current or the like, is generated on a circuit, the amount of heat generated and the curved level of the bimetal 66 may be increased. Accordingly, the bimetal 66 may press the crossbar 42 by the pressing member 66c such that the crossbar 42 can be rotated. The rotation of the crossbar 42 may unlock the latch (not illustrated) of the switching mechanism 40. Consequently, the movable contact 30 may be fast separated from the fixed contact 20.

During this process, the first arc-resistive member 168a may allow the flow of the current, with preventing the generation of arc, between the contact surface 62a of the first terminal 62 and the first contact surface 66a of the bimetal 66.

Also, the second arc-resistive member 168b may allow the flow of the current, with preventing the generation of arc, between the contact surface 64a of the second terminal 64 and the second contact surface 66b of the bimetal 66.

Here, the trip device 160 for the circuit breaker according to the first exemplary embodiment disclosed herein may be formed in a manner of plating the first and second arc-resistive members 168a and 168b, made of silver carbide (AgC), onto the first and second contact surfaces 66a and 66b of the bimetal 66, respectively.

Also, the first contact surface 66a of the bimetal 66 and the contact surface 62a of the first terminal 62 may come in surface-contact with each other, with interposing the first arc-resistive member 168a therebetween.

Also, the second contact surface 66b of the bimetal 66 and the contact surface 64b of the first terminal 64 may come in surface-contact with each other, with interposing the second arc-resistive member 168b therebetween.

With the configuration, the current may flow from the contact surface 62a of the first terminal 62 toward the contact surface 64b of the second terminal 64 sequentially along the first arc-resistive member 168a, the first contact surface 66a of the bimetal 66, the second contact surface 66b of the bimetal 66, and the second arc-resistive member 168b. The bimetal 66 may thus generate heat due to the flow of the current.

In such a manner, in the trip device 160 for the circuit breaker according to the first exemplary embodiment disclosed herein, the arc generation can be prevented between the contact surface 62a of the first terminal 62 and the first contact surface 66a of the bimetal 66 and between the contact surface 64b of the second terminal 64 and the second contact surface 66b of the bimetal 66. Accordingly, the thermal bonding and the thusly-caused changes in the resistance value, the amount of heat generated and the curved level of the bimetal 66 may be prevented. This may result in preventing reliability of the trip operation from being lowered due to the delayed trip.

In this case, in the trip device 160 for the circuit breaker according to the first exemplary embodiment disclosed herein, since the bimetal 66 is in the surface-contact state with both the first terminal 62 and the second terminal 64, the arc-resistive members have been provided at the two surface-contacted portions. However, if the bimetal 66 comes in surface-contact with only one of the first and second terminals 62 and 64, that is, the bimetal 66 is not in a surface-contacted state with the other but in a line-connected state therewith, the arc-resistive member may be formed only at the surface-contacted portion.

Also, in the trip device 160 for the circuit breaker according to the first exemplary embodiment disclosed herein, the first and second terminals 62 and 64 may merely serve to allow for the flow of the current, in order for the bimetal 66 to be curved due to the heat generated by itself in response to the current flowing therethrough, namely, curved in a direct manner. However, if the bimetal 66 is curved due to heat directly generated by itself in response to the current flowing therethrough and simultaneously curved by being heated by a heater, namely, curved in direct and indirect manners, the first or second terminal 62 or 64 may be provided with the heater to heat the bimetal 66 as well as allowing for the flow of the current. Here, the heating by the heater may correspond to one of a direct-heating scheme in which the heater comes in contact with the bimetal 66 to heat it in a conducting manner, a radiation scheme in which the heater faces the bimetal 66 with a preset gap therefrom to heat the bimetal 66 in a conducting or radiating manner, and a direct-radiation scheme in which a part of the heater comes in contact with the bimetal 66 to heat the bimetal in a conducting manner and another part of the heater faces the bimetal 66 with a preset gap therefrom to heat the bimetal in a conducting or radiating manner.

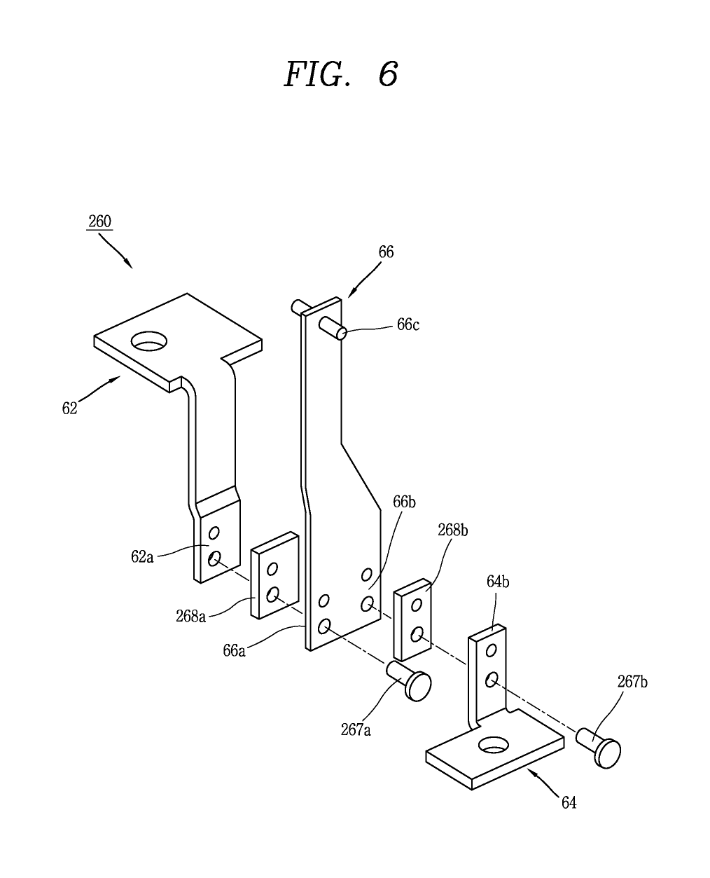

FIG. 6 is a disassembled perspective view of a trip device in accordance with a second exemplary embodiment disclosed herein.

As illustrated in FIG. 6, a trip device 260 for a circuit breaker according to a second exemplary embodiment disclosed herein may be configured in the same manner, excluding that arc-resistive members 268a and 268b formed of insulating paper are separately provided, instead of the first and second arc-resistive members 168a and 168b, which are formed by plating the bimetal 66 with the silver carbide (AgC) having arc-resistivity and conductivity.

That is, the trip device 260 for the circuit breaker according to the second exemplary embodiment disclosed herein may include a first terminal 62 connected to a power source side, a second terminal 64 connected to a load side, and a bimetal 66 having one side connected with the first terminal 62 and the other side connected with the second terminal 64 such that a current can flow, a first arc-resistive member 268a disposed between the first terminal 62 and the one side of the bimetal 66, a second arc-resistive member 268b disposed between the second terminal 64 and the other side of the bimetal 66, a first conductive rivet 267a inserted through the first terminal 62, the first arc-resistive member 268a and the one side of the bimetal 66, and a second conductive rivet 267b inserted through the second terminal 64, the second arc-resistive member 268b and the other side of the bimetal 66.

For reference, those components of FIG. 6 may be assembled into a shape of FIG. 3.

The first terminal 62 and the second terminal 64 may serve as brackets for supporting the bimetal 66 and simultaneously serve to electrically connect the bimetal 66 to a circuit.

The first terminal 62 may include a contact surface 62a which comes in surface-contact with one surface of the first arc-resistive member 268a to be explained later.

The second terminal 64 may include a contact surface 64b which comes in surface-contact with one surface of the second arc-resistive member 268b to be explained later.

The bimetal 66 may include a pressing member 66c provided on one end portion thereof.

The bimetal 66 may include a first contact surface 66a provided on one surface of the other end portion thereof to come in surface-contact with a rear surface of the first arc-resistive member 268a, and a second contact surface 66b provided on a rear surface of the other end portion thereof to come in surface-contact with a rear surface of the second arc-resistive member 268b.

The first arc-resistive member 268a and the second arc-resistive member 268b may be formed as a plate-like member.

The first arc-resistive member 268a may come in surface-contact with the contact surface 62a of the first terminal 62 at the one surface thereof, and with the first contact surface 66a of the bimetal 66 at the rear surface thereof.

The second arc-resistive member 268b may come in surface-contact with the contact surface 64b of the second terminal 64 at one surface thereof, and with the second contact surface 66b of the bimetal 66 at the rear surface thereof.

The first conductive rivet 267a and the second conductive rivet 267b may be formed as a rod-like member.

The first conductive rivet 267a may be inserted through the contact surface of the first terminal 62, the first arc-resistive member 268a and the first contact surface 66a of the bimetal 66, such that the bimetal 66 can be fixedly coupled to the first terminal 62.

The second conductive rivet 267b may be inserted through the contact surface 64b of the second terminal 64, the second arc-resistive member 268b and the second contact surface 66b of the bimetal 66, such that the bimetal 66 can be fixedly coupled to the second terminal 64.

The first conductive rivet 267a and the second conductive rivet 267b may be replaced with other conductive fastening members, such as bolts and the like.

In this case, the first arc-resistive member 268a may be formed of insulating paper, such as NOMEX, and implemented as a plate-like member, separate from the bimetal 66 and the first terminal 62. The first arc-resistive member 268a implemented as the plate-like member may be provided for insulation between the contact surface 62a of the first terminal 62 and the first contact surface 66a of the bimetal 66, so as to prevent arc generation between the contact surface 62a of the first terminal 62 and the first contact surface 66a of the bimetal 66.

The second arc-resistive member 268b may be formed of insulating paper, such as NOMEX, and implemented as a plate-like member, separate from the bimetal 66 and the second terminal 64. The second arc-resistive member 268b implemented as the plate-like member may be provided for insulation between the contact surface 64b of the second terminal 64 and the second contact surface 66b of the bimetal 66, so as to prevent arc generation between the contact surface 64b of the second terminal 64 and the second contact surface 66b of the bimetal 66.

Here, since the first and second conductive rivets 267a and 267b are formed of a conductive material, such as copper, a current may flow from the contact surface 62a of the first terminal 62 to the contact surface 64b of the second terminal 64 sequentially via the first conductive rivet 267a, the first contact surface 66a of the bimetal 66, the second contact surface 66b of the bimetal 66, and the second conductive rivet 267b.

The first arc-resistive member 268a and the second arc-resistive member 268b, as aforementioned, may be separately provided and coupled by use of the first and second conductive rivets 267a and 267b. Alternatively, the first arc-resistive member 268a and the second arc-resistive member 268b may also be coupled integrally with the bimetal 66 by being attached onto the first and second contact surfaces 66a and 66b of the bimetal 66, respectively, using an adhesive and the like.

The first arc-resistive member 268a and the second arc-resistive member 268b may also be coupled integrally with the first terminal 62 and the second terminal 64, respectively, by being attached onto the contact surface 62a of the first terminal 62 and the contact surface 64b of the second terminal 64, respectively, by use of an adhesive and the like.

The first arc-resistive member 268a and the second arc-resistive member 268b may also be separately formed of a different material having an insulation property so as to be riveted, or attached onto the bimetal 66 or the terminals 62 and 64.

In addition, in the bimetal 66, which is a bonded member having one surface and a rear surface made of different materials from each other, if the first terminal 62 and the second terminal 64 are connected to only one of the one surface and the rear surface, a material of the connected surface may be heated so as to be cut due to being melted or reversely curved. To prevent this, the bimetal 66 may be connected to the first terminal 62 at the first contact surface 66a which is one surface of the other end portion thereof, and connected to the second terminal 64 at the second contact surface 66b which is the rear surface of the other end portion thereof.

The same or equivalent parts as those of the related art are given with the same or equivalent reference numbers.

Hereinafter, operational effects of the trip device 260 for the circuit breaker according to the second exemplary embodiment disclosed herein will be described.

That is, in the trip device 260 for the circuit breaker according to the second exemplary embodiment disclosed herein, a current applied from a power source side may flow toward a load side sequentially along the contact surface 62a of the first terminal 62, the first conductive rivet 267a, the first contact surface 66a of the bimetal 66, the second contact surface 66b of the bimetal 66, the second conductive rivet 267b and the contact surface 64b of the second terminal 64.

Accordingly, the bimetal 66 may generate heat by the current flowing from the first contact surface 66a to the second contact surface 66b.

When a temperature of the bimetal 66 is raised due to the generated heat, the bimetal 66 may be curved to the right side in the drawing, referring to FIG. 6.

Here, the bimetal 66 may exhibit a less amount of heat generated and a low curved level when a normal current flows. Accordingly, the bimetal 66 may not trip the switching mechanism 40 of the circuit breaker.

However, when a fault current, such as a shortcircuit current or the like, is generated on a circuit, the amount of heat generated and the curved level of the bimetal 66 may be increased. Accordingly, the bimetal 66 may press the crossbar 42 by the pressing member 66c such that the crossbar 42 can be rotated. The rotation of the crossbar 42 may unlock the latch (not illustrated) of the switching mechanism 40. Consequently, the movable contact 30 may be fast separated from the fixed contact 20.

During this process, the first arc-resistive member 268a may prevent the arc generation by insulating the contact surface 62a of the first terminal 62 and the first contact surface 66a of the bimetal 66 from each other.

Also, the second arc-resistive member 268b may prevent the arc generation by insulating the contact surface 64a of the second terminal 64 and the second contact surface 66b of the bimetal 66 from each other.

Here, since a current is unable to flow due to the insulation by the first arc-resistive member 268a and the second arc-resistive member 268b, the first conductive rivet 267a and the second conductive rivet 267b, both formed of the conductive material, may serve as lines, as aforementioned.

Here, the trip device 260 for the circuit breaker according to the second exemplary embodiment disclosed herein may separately employ the first arc-resistive member 268a and the second arc-resistive member 268b both formed of the insulating paper, such as NOMEX.

Also, the first contact surface 66a of the bimetal 66 and the contact surface 62a of the first terminal 62 may come in surface-contact with each other, with interposing the first arc-resistive member 268a therebetween, and coupled to each other by the first conductive rivet 267a inserted therethrough.

The second contact surface 66b of the bimetal 66 and the contact surface 64b of the second terminal 64 may come in surface-contact with each other, with interposing the second arc-resistive member 268b therebetween, and coupled to each other by the second conductive rivet 267b inserted therethrough.

With the configuration, a current may flow from the contact surface 62a of the first terminal 62 toward the contact surface 64b of the second terminal 64 sequentially along the first conductive rivet 267a, the first contact surface 66a of the bimetal 66, the second contact surface 66b of the bimetal 66, and the second conductive rivet 267b. Accordingly, the bimetal 66 may generate heat by the flow of the current.

In such a manner, in the trip device 160 for the circuit breaker according to the first exemplary embodiment disclosed herein, the arc generation can be prevented between the contact surface 62a of the first terminal 62 and the first contact surface 66a of the bimetal 66 and between the contact surface 64b of the second terminal 64 and the second contact surface 66b of the bimetal 66. Accordingly, the thermal bonding and the thusly-caused changes in the resistance value, the amount of heat generated and the curved level of the bimetal 66 may be prevented. This may result in preventing reliability of the trip operation from being lowered due to the delayed trip.

In this case, in the trip device 260 for the circuit breaker according to the second exemplary embodiment disclosed herein, since the bimetal 66 is in the surface-contact state with both the first terminal 62 and the second terminal 64, the arc-resistive members have been provided at the two surface-contacted portions. However, if the bimetal 66 comes in surface-contact with only one of the first and second terminals 62 and 64, that is, the bimetal 66 is not in a surface-contacted state with the other but in a line-connected state therewith, the arc-resistive member may be formed only at the surface-contacted portion.

Also, in the trip device 260 for the circuit breaker according to the second exemplary embodiment disclosed herein, the first and second terminals 62 and 64 may merely serve to allow for the flow of the current, in order for the bimetal 66 to be curved due to the heat generated by itself due to the current flowing therethrough, namely, curved in a direct manner. However, if the bimetal 66 is curved due to heat directly generated by itself in response to the current flowing therethrough and simultaneously curved by being heated by a heater, namely, curved in direct and indirect manners, the first or second terminal 62 or 64 may be provided with the heater to heat the bimetal 66 as well as allowing for the flow of the current. Here, the heating by the heater may correspond to one of a direct-heating scheme in which the heater comes in contact with the bimetal 66 to heat it in a conducting manner, a radiation scheme in which the heater faces the bimetal 66 with a preset gap therefrom to heat the bimetal 66 in a conducting or radiating manner, and a direct-radiation scheme in which a part of the heater comes in contact with the bimetal 66 to heat the bimetal in a conducting manner and another part of the heater faces the bimetal 66 with a preset gap therefrom to heat the bimetal in a conducting or radiating manner.

Other components of the circuit breaker except for the trip device and their operational effects are the same as the related art, so description thereof will be omitted.

As described above, a trip device for a circuit breaker disclosed herein may include a first terminal connected to a power source side, a second terminal connected to a load side, and a bimetal having one side connected with the first terminal and the other side connected with the second terminal such that a current can flow, and the bimetal may come in surface-contact with at least one of the first terminal and the second terminal with interposing an arc-resistive member therebetween, so as to prevent arc generation between the contact surfaces. Accordingly, thermal bonding and changes of a resistance value, a quantity of heat generated, and a curved level of a bimetal can be prevented and consequently reliability of a trip operation can be prevented from being lowered due to a delayed trip.

Also, the trip device for the circuit breaker disclosed herein may be fabricated in an easier manner, by plating a metal, such as silver carbide (AgC) having arc-resistivity and conductivity, onto the bimetal or the terminals.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A trip device for a circuit breaker, comprising:
a first terminal connected to a power source side;
a second terminal connected to a load side; and
a bimetal having one side connected with the first terminal and the other side connected with the second terminal, such that a current can flow therethrough,
wherein the bimetal comes in surface-contact with at least one of the first terminal and the second terminal, with interposing an arc-resistive member therebetween.

2. The trip device of claim 1, wherein the arc-resistive member is formed of a metal having arc-resistivity and conductivity.

3. The trip device of claim 2, wherein the metal is silver carbide (AgC).

4. The trip device of claim 2, wherein the arc-resistive member is plated on a surface of the bimetal.

5. The trip device of claim 2, wherein the arc-resistive member is provided, separate from the bimetal, the first terminal and the second terminal.

6. The trip device of claim 1, wherein the arc-resistive member is formed of insulating paper, and
wherein a current flows along a conductive rivet inserted through the arc-resistive member.

7. The trip device of claim 6, wherein the insulating paper is NOMEX.

8. The trip device of claim 6, wherein the conductive rivet is formed of copper.

9. The trip device of claim 6, wherein the arc-resistive member is provided, separate from the bimetal, the first terminal and the second terminal.
